(19) United States
(12) Patent Application Publication
(10) Pub. No.: US 2007/0157640 A1
(43) Pub. Date: Jul. 12, 2007

(54) Temperature guard system for a refrigerator

(75) Inventors: Mary Kay Bolger, Williamsburg, IA (US); Nelson J. Ferragut II, Williamsburg, IA (US); Robert L. Wetekamp, Cedar Rapids, IA (US)

Correspondence Address: DIEDERIKS & WHITELAW, PLC, #301, 12471 Dillingham Square, Woodbridge, VA, 22192, US

(73) Assignee: Maytag Corp.

(21) Appl. No.: 11/327,427

(22) Filed: Jan. 9, 2006

(51) Int. Cl. G01K 13/00

(52) U.S. Cl. 62/129

(57) ABSTRACT

A refrigerator includes a controller for regulating temperatures established in a fresh food compartment and a freezer compartment of the refrigerator. The controller is selectively operable in a temperature guard mode providing a warm temperature alarm setting function and a power interrupt setting function. When the warm temperature alarm is active, the controller monitors temperatures of each of the fresh food compartment and the freezer compartment. If either temperature exceeds a respective predetermined value for a predetermined time, an alarm is activated to indicate a warm temperature condition. When the power interrupt alarm setting is selected, the controller senses an interruption and restoration of power. Once power is restored, if a temperature of either the fresh food compartment or the freezer compartment has exceeded a respective predetermined value, an alarm is activated to indicate an over-temperature condition. In addition, a high temperature value and an actual temperature value are displayed.

### BACKGROUND OF THE INVENTION

1. Field of the Invention

The present invention pertains to the art of refrigerators and, more particularly, to a refrigerator having a controller including a temperature guard mode for detecting an over-temperature condition in a fresh food and/or a freezer compartment of a refrigerator.

2. Discussion of the Prior Art

In general, a standard refrigerator includes a freezer compartment for maintaining foodstuffs at or below freezing, and a fresh food compartment for maintaining foodstuffs in a temperature zone below ambient temperature but above freezing temperatures. A typical refrigerator includes an electrically powered refrigeration system having at least a compressor, a condenser, a condenser fan, an evaporator, an evaporator fan and a plurality of temperature sensors.

In operation, a consumer selects a desired temperature for each of the fresh food and freezer compartments, or alternatively, a preset temperature value is provided by the manufacturer. Once power is introduced to the appliance, the refrigeration system operates to establish and maintain the selected temperatures within the fresh food and freezer compartments. During periods of normal use, each of the compartments is accessed several times during a typical day. Each time a compartment door is opened, the temperature inside the compartment rises due to an influx of warmer, ambient air. Sensors arranged within the compartments detect the rise in temperature and activate the refrigeration system to pull down the temperature to the initial level. Certainly, if the compartment is sealed, the refrigeration system will operate for a short time period in order to re-establish the temperature level. However, if the compartment remains open, i.e. the consumer fails to properly close a door, the refrigeration system will operate continuously in order to try to maintain the proper temperature level.

Obviously, with the door open, no matter how efficient the refrigeration system, the temperature of the compartment will likely not reach the desired level. The warmer, ambient temperature will enter and raise the temperature of the compartment. Left unchecked, the temperature could rise to a level that would detrimentally affect the quality of food stored within the appliance.

In addition to problems associated with opening doors, compartment temperatures will rise during periods of prolonged power interruption. When power is interrupted to the appliance, the refrigeration system is unable to function. Despite the existence of seals about the doors of the appliance, over time, at least conduction will cause the temperatures of the compartments to rise and, if power is interrupted for an extended period, food within the appliance could spoil. When power is restored, the refrigeration system will operate normally, pulling down the compartment temperature to the previous set level. If left unaware of the power interruption, a consumer may inadvertently consume spoiled food. The prior art contains a number of examples of systems that warn a consumer of an over-temperature condition in a refrigerator. That is, there exists systems that provide an indication of a warm temperature condition or a power interrupt condition. However, systems that present more detailed and meaningful information are not available.

Therefore, despite the presence of temperature alarms in the prior art, there still exists a need in the art for a temperature guard mode for a refrigerator that provides an indication to a consumer of an over-temperature condition resulting from, for example, an open door or from an interruption of power. Preferably, in the event of an over-temperature condition, a display will warn the consumer of the highest temperature reached in a fresh food and/or freezer compartment so that the consumer may make an informed decision regarding the quality of the food stored within the appliance.

### SUMMARY OF THE INVENTION

The present invention is directed to a refrigerator including an outer shell or cabinet having defined therein a fresh food compartment and a freezer compartment. A door is pivotally mounted to the cabinet to provide selective access to at least one of the fresh food and freezer compartments. In a manner known in the art, the refrigerator includes a refrigeration system for establishing and maintaining desired temperatures in the fresh food and freezer compartments. In a manner also known in the art, the refrigerator is provided with a user interface that includes a display and a plurality of control elements. The display provides a consumer information about, for example, the temperature of the fresh food and/or freezer compartment, as well as various other conditions that exist in the refrigerator. In addition, the control elements provide the consumer with the means for selectively adjusting various operating parameters of the refrigerator.

In accordance with the invention, the refrigerator includes a controller operatively coupled to the user interface. The controller is operable in a temperature guard mode so as to provide a warm temperature alarm setting function and a power interrupt alarm setting for the refrigerator. When selected, the warm temperature alarm setting function monitors the temperatures of both the fresh food compartment and the freezer compartment. If either temperature exceeds a predetermined value or alarm temperature for a predetermined time, an alarm is activated to indicate a warm temperature condition. In this manner, a consumer can rectify whatever situation is causing the temperature to rise and prevent food from spoiling. In addition, once the alarm is activated, a display presents information to the consumer regarding the status of the affected compartment(s). More specifically, the display preferably presents a read-out representing an actual/current temperature of the affected compartment, alternately flashing a readout representing a highest temperature value reached in the affected compartment(s).

When the power interrupt alarm setting is selected, the controller senses an interruption of power to the refrigerator, as well as a restoration of power. Once power is restored, if the temperature of either the fresh food compartment or the freezer compartment has exceeded a predetermined value, an alarm is activated to indicate an over-temperature condition. In a manner similar to that described above, the display is activated to provide a read out showing both a high temperature value and an actual/current temperature value. In this manner, a consumer can readily determine if food stored in the refrigerator has been exposed to adversely high temperatures.

Additional objects, features and advantages of the present invention will become more readily apparent from the following detailed description of a preferred embodiment when taken in conjunction with the drawings wherein like reference numerals refer to corresponding parts in the several views.

### BRIEF DESCRIPTION OF THE DRAWINGS

FIG. 1 is a perspective view of a refrigerator incorporating a temperature guard mode including a warm temperature alarm setting and a power interrupt alarm setting constructed in accordance with the present invention;

FIG. 2 is a flow chart illustrating the operational steps associated with the warm temperature alarm setting; and

FIG. 3 is a flow chart illustrating the operational steps associated with the power interrupt alarm setting.

### DETAILED DESCRIPTION OF THE PREFERRED EMBODIMENT

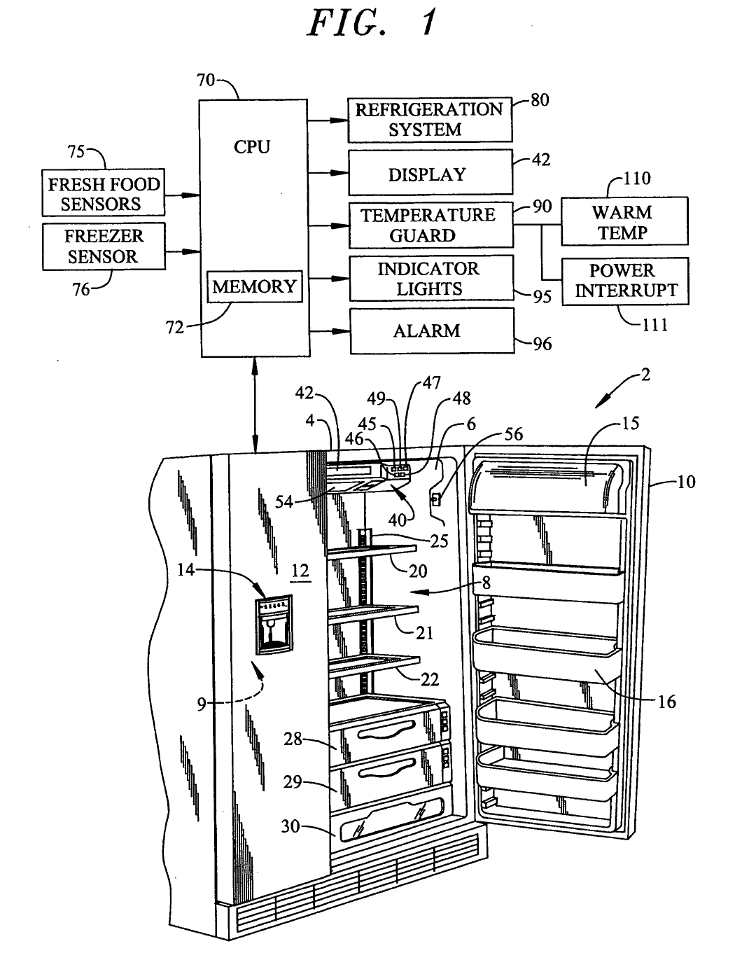

With initial reference to FIG. 1, a refrigerator 2 includes an outer shell or cabinet 4 within which is positioned a liner 6 that defines a fresh food compartment 8. Another liner (not shown) is positioned in cabinet 4 to establish a freezer compartment 9. In a manner known in the art, fresh food compartment 8 can be accessed by the selective opening of a fresh food door 10. In a similar manner, a freezer door 12 can be opened to access freezer compartment 9. In the embodiment shown, freezer door 12 includes a dispenser 14 that enables a consumer to retrieve ice and/or fresh water without accessing fresh food or freezer compartments 8 and 9. For the sake of completeness, door 10 of refrigerator 2 is shown to include a dairy compartment 15 and various vertically adjustable shelving units, one of which is indicated at 16.

In a manner also known in the art, fresh food compartment 8 is provided with a plurality of vertically height adjustable shelves 20-22 supported by a pair of shelf support rails, one of which is indicated at 25. At a lowermost portion of fresh food compartment 8 is illustrated various temperature controlled bins 28 and 29, as well as a conventional storage compartment 30. At an upper region of fresh food compartment 8 is a temperature control housing or user interface 40. In the embodiment shown, interface 40 includes a display zone 42 and a plurality of control elements 45-49. Control elements 45-48 are constituted by temperature control elements for adjusting temperatures in fresh food compartment 8 and freezer compartment 9, while control element 49 is constituted by an auxiliary control element for re-setting, for example, an alarm condition. For the sake of completeness, interface 40 includes a light 54 which, in a manner known in the art, is controlled by a switch 56 operated by opening and closing door 10.

In accordance with the invention, refrigerator 2 includes a controller or CPU 70 having a memory 72. Controller 70 receives inputs from temperature sensors 75 and 76 located in fresh food compartment 8 and freezer compartment 9 respectively. Sensors 75 and 76 provide signals to controller 70 resulting in selective operation of a refrigeration system 80 in order to maintain temperatures within each respective compartment 8 and 9. Occasionally, temperatures in fresh food and freezer compartments 8 and 9 will rise above minimum required levels for maintaining food or other items at proper storage conditions. That is, as a result of door 10 or 12 being left open or an interruption of power to refrigerator 2, the compartment temperature(s) may rise to undesirable levels. Toward that end, controller 70 is provided with a temperature guard mode 90 which, upon sensing an over-temperature condition, activates indicator lights 95 and an alarm 96 to provide a consumer with both a visual and audible warning of an over-temperature condition. More specifically, temperature guard mode 90 includes a warm temperature alarm setting 110, as well as a power interrupt alarm setting 111, each of which may be selectively activated based upon particular demands or consumer requirements.

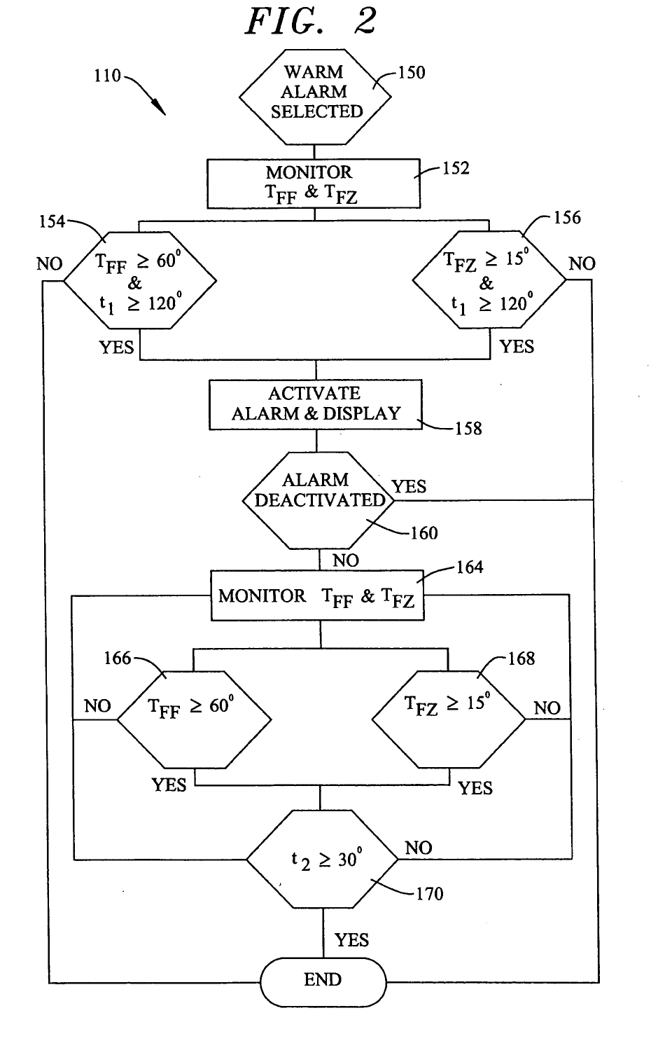

Reference will now be made to FIG. 2 in describing the preferred mode of operation of warm temperature alarm setting 110. When in temperature guard mode 90, controller 70 initially determines whether warm temperature alarm setting 110 is selected in step 150. If selected, controller 70 begins monitoring temperatures in fresh food compartment 8 and freezer compartment 9 in step 152. In step 154, the controller senses whether the temperature of fresh food compartment 8 (TFF) is equal to or exceeds 60° F. (15.5° C.) for a predetermined time period, for example, two hours. Likewise, in step 156, controller 70 senses whether the temperature of freezer compartment 9 is equal to or exceeds 15° F. (−9.5° C.) for a predetermined period. If a positive indication is returned in step 154 and/or 156, a warm indication is set and controller 70 activates visual indicator lights 95, as well as an audible alarm 96. In addition, display 42 is activated to provide an indication of actual compartment temperature in refrigerator compartment 8 and/or freezer compartment 9, as well as the warmest or highest temperature achieved in either compartment.

Once indicator lights 95, alarm 96 and display 42 are active, the consumer has the option of deactivating either one or all of the indicators. Specifically, a consumer can, for example, activate control element 49 for a period of, for example, one second, to deactivate alarm 96, while maintaining the activation of indicator lights 95 and display 42. Alternatively, a consumer can press and hold control element 49 for a period of, for example 3 seconds, to totally deactivate warm temperature alarm setting 110. In either case, CPU 70, in step 160, checks whether warm temperature alarm setting 110 has been deactivated. If warm temperature alarm setting 110 remains active, the temperatures in fresh food compartment 8 and freezer compartment 9 continue to be monitored in step 164. If, the temperature of fresh food compartment 8 returns below 60° F. (15.5° C.) as noted in step 166, for a second predetermined time period, e.g., 30 minutes as checked in step 170, the warm temperature alarm setting 110 for fresh food compartment 8 is deactivated. Likewise, if in step 172, controller 70 senses that the temperature of freezer compartment 9 is lower than 15° F. (−9.5° C.) and, step 170 returns a positive value that the second time period has lapsed, the warm temperature alarm setting 110 for freezer compartment 9 is likewise deactivated. Indicator lights 95 and alternating maximum temperatures achieved are displayed until the user takes action thereby ensuring that the consumer is aware of the warm condition.

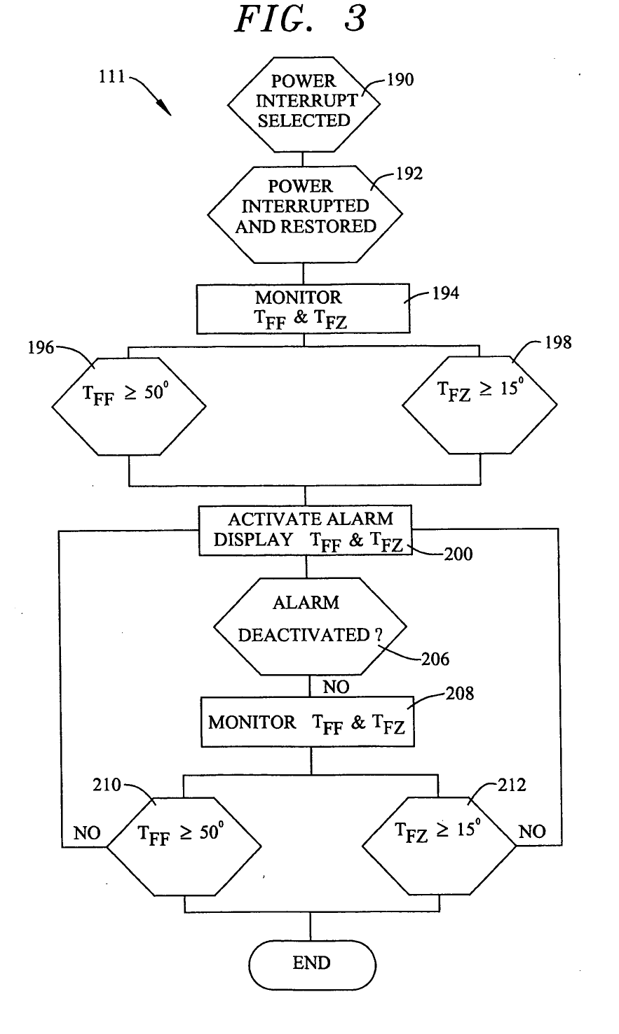

Reference will now be made to FIG. 3 in describing the operation of power interrupt alarm setting 111. When operating in temperature guard mode 90, in addition to sensing whether warm temperature alarm setting 110 is selected in step 150, controller 70 also checks whether power interrupt alarm setting 111 is active in step 190. If active, controller 70 continues to monitor for an interruption of power and restoration of power to refrigerator 2 in step 192. After sensing an interruption and subsequent restoration of power to refrigerator 2, controller 70 monitors temperatures of fresh food compartment 8 and freezer compartment 9 in step 194. If the temperature of fresh food compartment (TFF) exceeds 50° F. (10° C.) for any period of time as sensed in step 196 or the temperature of freezer compartment (TFZ) exceeds 15° F. (−9.5° C.) for any period of time as sensed in step 198, controller 70 sets a warm indication and activates indicator lights 95, alarm 96 and display 42 in step 200.

In accordance with the most preferred form of the invention, display 42 provides an indication of current compartment temperatures, as well as the highest temperature reached in each compartment 8 and 9 respectively. At this point, a consumer has the option of disabling power interrupt alarm setting 111 through, for example, control element 49. At this point, audible alarm 96 is silenced while indicator lights 95 and display 42 continue to provide an indication of the alarm condition. If, however, the consumer simply wants to completely deactivate or shut-off the alarm condition, control element 49 can be activated for a period of, for example, three seconds and power interrupt alarm setting 111 is completed disabled.

As long as power interrupt alarm setting 111 remains active, controller 70 continues to monitor the temperature in fresh food compartment 8 and freezer compartment 9 in step 208. In accordance with the invention, the alarm condition will persist until the temperature of fresh food compartment 8 is below 50° F. (10° C.) in step 210 or the temperature of freezer compartment 9 drops below 15° F. (−9.5° C.) in step 212. In any case, once the temperature of fresh food compartment 8 and freezer compartment 9 have returned to desirable levels, indicator lights 95 continue to flash and display 42 continues to alternately display actual compartment temperatures and the highest temperature achieved in each compartment 8, 9 until deactivated by a consumer. In this manner, the consumer is provided with an indication the actual temperatures achieved in fresh food compartment 8 and/or freezer compartment 9 such that a determination can be made as to the quality of food contained within refrigerator 2.

Although described with reference to a preferred embodiment of the invention, it should be readily understood that various changes and/or modifications can be made to the invention without departing from the spirit thereof. For instance, the particular temperatures which can trigger the warm temperature alarm setting or the power interrupt setting can vary. Also, the manner in which either alarm setting can be deactivated may vary. Finally, while the user interface is shown in a top portion of the fresh food compartment, alternate locations, such as being mounted on a door of the refrigerator, are also acceptable. In general, the invention is only intended to be limited by the scope of the following claims.

I/we claim:

1. A refrigerator comprising:
a cabinet having defined therein fresh food and freezer compartments;
fresh food and freezer doors pivotally mounted relative to the cabinet for selectively closing the fresh food and freezer compartments respectively;
a user interface including a display and a plurality of control elements for selectively adjusting operating parameters of the refrigerator; and
a controller operatively coupled with the user interface, said controller being operable in a temperature guard mode providing a warm temperature alarm setting function and a power interrupt alarm setting function wherein:
a) in accordance with the warm temperature alarm setting function, a fresh food compartment temperature and a freezer compartment temperature are monitored and, if either the fresh food compartment temperature or the freezer compartment temperature exceeds a predetermined value for a predetermined time, said controller activates an alarm to indicate a warm temperature condition; and
b) in accordance with the power interrupt alarm setting function, an initial interruption of power to the refrigerator and a subsequent restoration of power are sensed and, upon restoration of power, if the fresh food compartment temperature or the freezer compartment temperature has exceeded a predetermined value, the controller activates an alarm to indicate an over-temperature condition, while both a high temperature value and an actual temperature value are shown in the display.

2. A refrigerator comprising:
a cabinet having defined therein fresh food and freezer compartments;
fresh food and freezer doors pivotally mounted relative to the cabinet for selectively closing the fresh food and freezer compartments respectively;
a user interface including a display and a plurality of control elements for selectively adjusting operating parameters of the refrigerator; and
a controller operatively coupled with the user interface, said controller being operable in a temperature guard mode providing a power interrupt alarm setting function wherein an initial interruption of power to the refrigerator and a subsequent restoration of power are sensed and, upon restoration of power, if the fresh food compartment temperature or the freezer compartment temperature has exceeded a predetermined value, the controller activates an alarm to indicate an over-temperature condition, while a high temperature value is shown in the display.

3. The refrigerator according to claim 2 wherein, in accordance with the power interrupt alarm setting function, an actual temperature in one of the fresh food and freezer compartments is also shown in the display with the high temperature value.

4. The refrigerator according to claim 3, wherein the high temperature value and the actual temperature are alternately flashed in the display.

5. The refrigerator according to claim 2, wherein the temperature guard mode can be manually reset through the user interface.

6. The refrigerator according to claim 2, wherein the temperature guard mode also includes a power interrupt alarm setting function, wherein an initial interruption of power to the refrigerator and a subsequent restoration of power are sensed and, upon restoration of power, if the fresh food compartment temperature or the freezer compartment temperature has exceeded a predetermined value, the controller activates an alarm to indicate an over-temperature condition.

7. The refrigerator according to claim 6 wherein, in accordance with the power interrupt alarm setting function, a high temperature value is shown in the display.

8. The refrigerator according to claim 7 wherein, in further accordance with the power interrupt alarm setting function, an actual temperature in one of the fresh food and freezer compartments is also shown in the display with the high temperature value.

9. The refrigerator according to claim 7, wherein the high temperature value and the actual temperature are alternately flashed in the display.

10. The refrigerator according to claim 6, wherein the power interrupt alarm setting function can be manually reset through the user interface.

11. A method of operating a refrigerator including a fresh food compartment, a freezer compartment and a temperature guard mode including a warm temperature alarm setting function and a power interrupt alarm setting function comprising:
when operating the warm temperature alarm function:
a) setting an alarm temperature for each of the fresh food compartment and the freezer compartment;
b) determining if either a high temperature of the fresh food compartment or a high temperature of the freezer compartment exceeds a respective said alarm temperature for a predetermined time; and
c) activating an alarm to indicate a warm temperature condition when the respective alarm temperature is exceeded for the predetermined time; and
when operating the power interrupt alarm setting function:
a) sensing an initial interruption of power to the refrigerator;
b) sensing a subsequent restoration of power;
c) determining if a high temperature of the fresh food compartment or a high temperature of the freezer compartment has exceeded a predetermined value; and
d) activating an alarm to indicate an over-temperature condition when the predetermined value is exceeded.

12. The method of claim 11, further comprising: displaying the high temperature value in a display when an alarm is indicated when operating in accordance with either the warm temperature setting function or the power interrupt alarm setting function.

13. The method of claim 12, further comprising: displaying an actual temperature in one of the fresh food and freezer compartments in the display with the high temperature value.

14. The method of claim 13, further comprising: alternately flashing the high temperature value and the actual temperature in the display.

15. The method of claim 11, further comprising: manually resetting a select one of the warm temperature alarm function and the power interrupt alarm setting function through a user interface provided as part of the refrigerator.
